(19) United States
(12) Patent Application Publication
(10) Pub. No.: US 2026/0011112 A1
(43) Pub. Date: Jan. 8, 2026

(54) DEVICE AND METHOD WITH POINT CLOUD DATA PROCESSING

(71) Applicant: SAMSUNG ELECTRONICS CO., LTD., Suwon-si (KR)

(72) Inventors: Siyang PAN, Beijing (CN); Jiaqian YU, Beijing (CN); Yiwei CHEN, Beijing (CN)

(73) Assignee: SAMSUNG ELECTRONICS CO., LTD., Suwon-si (KR)

(21) Appl. No.: 19/077,641

(22) Filed: Mar. 12, 2025

(30) Foreign Application Priority Data
Jul. 3, 2024 (CN) 202410889667.5
Oct. 8, 2024 (KR) 10-2024-0136816

(51) Int. Cl. G06V 10/44; G06V 10/82

(52) U.S. Cl. CPC G06V 10/454; G06V 10/82

(57) ABSTRACT

A processor-implemented method includes obtaining point cloud data comprising records indicating positions and attributes of a plurality of points, sorting the records according to an order of the plurality of points determined based on the positions of the plurality of points, extracting features of the plurality of points, based on a result obtained by applying a feature extraction model to input data based on the sorted records, and processing the point cloud data based on the features of the plurality of points.

### CROSS-REFERENCE TO RELATED APPLICATIONS

This application claims the benefit under 35 USC § 119 (a) of Chinese Patent Application No. 202410889667.5, filed on Jul. 3, 2024 in the China National Intellectual Property Administration, and Korean Patent Application No. 10-2024-0136816, filed on Oct. 8, 2024 in the Korean Intellectual Property Office, the entire disclosures of which are incorporated herein by reference for all purposes.

### BACKGROUND

### 1. Field

The following description relates to a device and method with point cloud data processing.

### 2. Description of Related Art

Point cloud data may be a set of vectors in a three-dimensional (3D) coordinate system. Information of each point of the point cloud data may include a 3D coordinate, and some pieces of information may include attribute information of a point such as color information and reflection intensity information. Since a point cloud may provide rich data with more dimensions, the point cloud may better recognize and understand a complex scenario based on point cloud data.

Point cloud data processing is more complex than an existing two-dimensional (2D) image. Although various processing methods are provided in related technology for processing point cloud data, these processing methods still need improvement.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes obtaining point cloud data comprising records indicating positions and attributes of a plurality of points, sorting the records according to an order of the plurality of points determined based on the positions of the plurality of points, extracting features of the plurality of points, based on a result obtained by applying a feature extraction model to input data based on the sorted records, and processing the point cloud data based on the features of the plurality of points.

Each of the records may include coordinate values of a plurality of coordinate axis directions indicating a position of a point corresponding to a corresponding record, and the sorting of the records may include determining the order of the plurality of points, based on priorities assigned to the plurality of coordinate axis directions.

The determining of the order of the plurality of points may include, based on a difference between coordinate values in a first coordinate axis direction between two points being less than or equal to a threshold value, determining that the difference between the coordinate values in the first coordinate axis direction between the two points does not exist.

The sorting of the records may include selecting a reference point from among the plurality of points, determining, among points of which an order is not determined among the plurality of points, an order of a target point that is closest to the reference point to be a next order of the reference point, and repeatedly updating the target point to the reference point and repeatedly determining the order of the target point, based on the updated reference point, until an order of all the plurality of points is determined.

Each of the records may include item values of a plurality of items comprising a position item and an attribute item, and the extracting of the features of the plurality of points may include, using each item of the sorted records as one channel, obtaining the input data comprising the sorted records with a plurality of channels.

The feature extraction model may include a one-dimensional (1D) convolutional neural network (CNN) comprising a 1D convolution operation that determines a convolution with an input while sliding a kernel, which is a 1D tensor, along one axis.

The feature extraction model may include a first convolution module comprising a 1D convolution operation and a second convolution module comprising a 1D convolution operation, the sorting of the records may include sorting the records in a first order of the plurality of points determined according to a first reference assigned to the first convolution module, and the extracting of the features of the plurality of points may include obtaining intermediate features of the plurality of points, based on a result obtained by applying the first convolution module to first input data based on the records sorted in the first order, and obtaining the features of the plurality of points, based on a result obtained by applying the second convolution module to second input data based on the obtained intermediate features.

The extracting of the features of the plurality of points further may include sorting the intermediate features in a second order of the plurality of points determined according to a second reference assigned to the second convolution module, and applying the second convolution module to the second input data based on the intermediate features sorted in the second order.

The feature extraction model may include a first convolution layer and a second convolution layer, and the extracting of the features of the plurality of points may include extracting, in the first convolution layer, item mixture features indicating features based on item values of items for each of the points, based on a 1D convolution of a first kernel and the input data, wherein the 1D convolution of the first kernel and the input data is determined while sliding the first kernel, which is a 1D tensor, along an item axis of the input data, and extracting, in the second convolution layer, spatial mixture features indicating features between each of the points and an adjacent one of the points that is adjacent to a corresponding one of the points, based on a 1D convolution of a second kernel and the input data, wherein the 1D convolution of the second kernel and the input data is determined while sliding the second kernel, which is a 1D tensor, along a point axis of the input data.

The obtaining of the point cloud data may include obtaining primary point cloud data corresponding to a first time point, and obtaining secondary point cloud data corresponding to a second time point that is temporally adjacent to the first time point, the sorting of the records may include determining an order of points in an entire point set comprising first points of the primary point cloud data and second points of the secondary point cloud data, and sorting records of the primary point cloud data and records of the secondary point cloud data according to the determined order of the points in the entire point set, the extracting of the features of the plurality of points may include obtaining features of the points in the entire point set using the feature extraction model, and the processing of the point cloud data may include, among the features of the points in the entire point set, processing the primary point cloud data using features of the first points.

The point cloud data may include the records respectively corresponding to the plurality of points, and each of the records of the point cloud data may include an item value of one or more position items indicating a position of a corresponding point and an item value of one or more attribute items indicating an attribute of a corresponding point.

The one or more attribute items may include one or more color items or reflection intensity item.

The processing of the point cloud data may include dividing the plurality of points into a plurality of partial point sets by classifying the plurality of points, based on the features of the plurality of points.

The processing of the point cloud data may include determining an object corresponding to one or more points, based on the features of the plurality of points.

In one or more general aspects, a non-transitory computer-readable storage medium may store code that, when executed by one or more processors, configures the one or more processors to perform any one, any combination, or all of operations and/or methods disclosed herein.

In one or more general aspects, an electronic device includes one or more processors configured to obtain point cloud data comprising records indicating positions and attributes of a plurality of points, sort the records according to an order of the plurality of points determined based on the positions of the plurality of points, extract features of the plurality of points, based on a result obtained by applying a feature extraction model to input data based on the sorted records, and process the point cloud data based on the features of the plurality of points.

Each of the records may include coordinate values of a plurality of coordinate axis directions indicating a position of a point corresponding to a corresponding record, and the one or more processors may be configured to determine the order of the plurality of points, based on priorities assigned to the plurality of coordinate axis directions.

For the sorting of the records, the one or more processors may be configured to select a reference point from among the plurality of points, determine, among points of which an order is not determined among the plurality of points, an order of a target point that is closest to the reference point to be a next order of the reference point, and repeatedly update the target point to the reference point and repeatedly determine the order of the target point, based on the updated reference point, until an order of all the plurality of points is determined.

The feature extraction model may include a first convolution module comprising a one-dimensional (1D) convolution operation and a second convolution module comprising a 1D convolution operation, and the one or more processors may be configured to for the sorting of the records, sort the records in a first order of the plurality of points determined according to a first reference assigned to the first convolution module, for the extracting of the features of the plurality of points, obtain intermediate features of the plurality of points, based on a result obtained by applying the first convolution module to first input data based on the records sorted in the first order, and for the extracting of the features of the plurality of points, obtain the features of the plurality of points, based on a result obtained by applying the second convolution module to second input data based on the obtained intermediate features.

The feature extraction model may include a first convolution layer and a second convolution layer, and for the extracting of the features of the plurality of points, the one or more processors may be configured to extract, in the first convolution layer, item mixture features indicating features based on item values of items for each point, based on a 1D convolution of a first kernel and the input data, wherein the 1D convolution of the first kernel and the input data is determined while sliding the first kernel, which is a 1D tensor, along an item axis of the input data, and extract, in the second convolution layer, spatial mixture features indicating features between each point and an adjacent point that is adjacent to a corresponding point, based on a 1D convolution of a second kernel and the input data, wherein the 1D convolution of the second kernel and the input data is determined while sliding the second kernel, which is a 1D tensor, along a point axis of the input data.

Other features and aspects will be apparent from the following detailed description, the drawings, and the claims.

### BRIEF DESCRIPTION OF THE DRAWINGS

FIG. 1 illustrates an example of a method performed by an electronic device.

FIG. 2 illustrates an example of point cloud data.

FIG. 3 illustrates an example of a method performed by an electronic device.

FIG. 4A illustrates an example of point cloud data.

FIG. 4B illustrates an example of sorting pieces of point cloud data.

FIG. 5A illustrates an example of point cloud data.

FIG. 5B illustrates an example of sorting pieces of point cloud data.

FIG. 6A illustrates an example of an operating principle of a convolutional neural network (CNN).

FIG. 6B illustrates an example of a structure of a one-dimensional (1D) convolution module.

FIG. 7 illustrates an example of a method performed by an electronic device.

FIG. 8 illustrates an example of a method, performed by an electronic device, of processing point cloud data.

FIG. 9 illustrates an example of an electronic device.

Throughout the drawings and the detailed description, unless otherwise described or provided, the same drawing reference numerals may be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The terms used herein are not limited to their dictionary meanings and are used to ensure a clear and consistent understanding of the present disclosure. It is clear to those skilled in the art that this detailed technique is only a desired implementation, and the purpose of the present disclosure is not limited according to the appended claims and equivalents thereof.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” to specify the presence of stated features, numbers, operations, members, elements, and/or combinations thereof, other embodiments may exist where one or more of the stated features, numbers, operations, members, elements, and/or combinations thereof are not present.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on,” “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The term “or” as used in various examples of the present disclosure includes any and all combinations of one or more of the respective listed items. For example, “A or B” could include A, could include B, or could include both A and B. When describing two or more items, if the relationship between the items is not clearly defined, it may refer to one, several, or all the items. For example, “A includes A1, A2, and A3” may be implemented as including A1 or A2 or A3 or as including at least two of A1, A2, and A3.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, should be construed to have meanings matching with contextual meanings in the relevant art and the disclosure of the present application, and are not to be construed to have an ideal or excessively formal meaning unless otherwise defined herein. The use of the term “may” herein with respect to an example or embodiment, e.g., as to what an example or embodiment may include or implement, means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment,” and “one or more examples” has a same meaning as “in one or more embodiments”).

Although terms such as “first,” “second,” and “third,” or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but is used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

At least some of the functions of a method or an electronic device may be implemented through an artificial intelligence (AI) model, and for example, at least one operation of the method performed by the electronic device may be implemented through the AI model. The functions related to AI may be performed by a non-volatile memory, a volatile memory, or a processor.

The processor may include at least one processor. In this case, the at least one processor may be a general-purpose processor, such as a central processing unit (CPU), an application processor (AP), etc., and/or a pure graphics processing unit (GPU), such as a GPU, a visual processing unit (VPU), and/or an AI-only processor, such as a neural processing unit (NPU).

The at least one processor may control processing of input data based on a predefined operation rule or AI model stored in the non-volatile memory and the volatile memory. The predefined operation rule or AI model may be provided through training or learning.

Herein, providing the predefined operation rule or AI model through learning may indicate obtaining a predefined operation rule or AI model with desired characteristics by applying a learning algorithm to a plurality of pieces of training data. The training or learning may be performed by the electronic device itself or by a separate server and/or system.

The AI model may include a plurality of neural network layers. Each of the plurality of neural network layers may include a plurality of weight values, and a neural network operation of each layer may be performed by an operation between input data (e.g., the operation result of a previous layer and/or input data of the AI model) of the layer and a plurality of weight values of a current layer. For example, a neural network may include, but is not limited thereto, a convolutional neural network (CNN), a deep neural network (DNN), a recurrent neural network (RNN), a restricted Boltzmann machine (RBM), a deep belief network (DBN), a bidirectional recurrent deep neural network (BRDNN), a generative adversarial network (GAN), and a deep Q-network.

The learning algorithm may be a method of training a predetermined target device (e.g., a robot) using multiple pieces of training data and enabling, allowing, and/or controlling the predetermined target device to perform determination and/or prediction. The learning algorithm may include, for example, but is not limited thereto, supervised learning, unsupervised learning, semi-supervised learning, and/or reinforcement learning.

A method provided herein may relate to at least one of technical fields, such as speech, language, image, video, and/or data intelligence.

Optionally, in the field of speech or language, the method performed by the electronic device may receive a speech signal of an analog signal through an audio collection apparatus (e.g., a microphone) and convert the speech into computer-readable text using an automatic speech recognition (ASR) model. The intent of a user language may be obtained by interpreting the converted text using a natural language understanding (NLU) model. The AI model may be processed by an AI-only processor, the AI-only processor is configured as a hardware structure designated for processing the AI model. The AI model may be obtained through training. Here, “being obtained through training” may refer to obtaining the predefined operation rule or AI model configured to perform a desired feature (or objective) by training a basic AI model with a plurality of pieces of training data through a training algorithm. Linguistic understanding is a technique of recognizing, applying, and/or processing human language (e.g., text) and includes natural language processing, machine translation, dialogue systems, question and answer, and speech recognition (or synthesis).

Optionally, in the field of image or video, the method performed by the electronic device may obtain output data that identifies related information from an image or image pair using image data as input data of the AI model. The AI model may be obtained through training. The electronic device may be used in the field of visual understanding of AI technology. Visual understanding may refer to technology for identifying and processing objects like human vision. For example, visual understanding may include object recognition, object tracking, image search, human recognition, scenario recognition, three-dimensional (3D) reconstruction, 3D positioning, or image enhancement.

Optionally, in the field of data smart processing, the method performed by the electronic device may process (e.g., recommend) a corresponding operation using input data through the AI model. The processor of the electronic device may convert data into a form that is suitable for use as an input of the AI model by preprocessing the data. Inference prediction may refer to technology for performing logical inference and prediction based on determined information. For example, inference prediction may include knowledge-based inference, optimized prediction, preference-based planning, or recommendations.

The method performed by the electronic device relates to processing point cloud data and may also be expressed as a point cloud data processing method. The point cloud data processing method may obtain features of each point of the point cloud data using the AI model (hereinafter, also referred to as an AI model, an AI network, and/or a neural network) trained based on the point cloud data. In response to obtaining the features of each point, the point cloud data processing method may include post-processing the point cloud data according to the features of each point. The point cloud data processing method may include performing different post-processing on the point cloud data performed based on the features of each point of a point cloud according to an actual application scenario and/or application requirements. For example, the point cloud data processing method may perform a downstream task, such as point cloud detection or point cloud division, based on information of the features of each point of the point cloud data.

The point cloud data may be disordered and irregular, unlike a two-dimensional (2D) image. The AI model may generally require a form of input data. Accordingly, it may be difficult for the point cloud data to be directly input to the AI model like a 2D image, and thus the point cloud data may undergo preprocessing prior to being input to the AI model. Regularized (e.g. preprocessed) point cloud data may vary from each other depending on a preprocessing method, and the downstream task may need to be completed following the configuration of an appropriate network structure that understands the point cloud data.

While it may be advantageous to regularize the point cloud data and configure a corresponding neural network structure, in regularizing the point cloud data, a typical device and method may not prevent information loss while guaranteeing efficient processing, may cause information loss of the point cloud data, and/or may have an unsatisfactory processing effect due to an enormous amount of operations.

In contrast, the solution provided herein may solve or improve at least one technical problem in the existing technology, thereby improving the processing effect of the point cloud data. For example, in regularizing the point cloud data, a device and method of one or more embodiments may prevent information loss while guaranteeing efficient processing, may prevent information loss of the point cloud data, and may have a satisfactory processing effect.

Hereinafter, the technical solution and technical effect are described through several optional examples. Unless there is no conflict or contradiction between different examples, various examples may refer to or be combined with each other, and the specific description of common terms, similar features, and operations included in various examples is omitted from the repeated configuration.

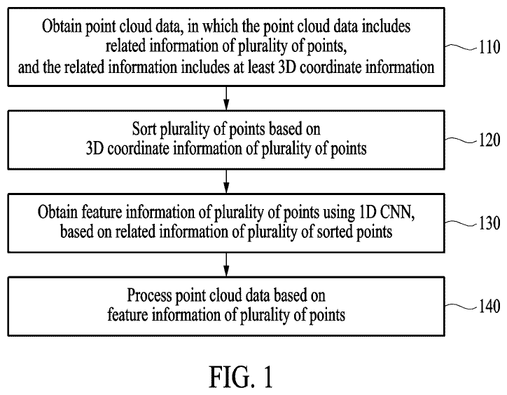

FIG. 1 illustrates an example of a method performed by an electronic device. Operations 110 to 140 to be described hereinafter may be performed sequentially in the order and manner as shown and described below with reference to FIG. 1, but the order of one or more of the operations may be changed, one or more of the operations may be omitted, and two or more of the operations may be performed in parallel or simultaneously without departing from the spirit and scope of the example embodiments described herein.

The electronic device may be a user terminal or a server. The server may be a physical server, a physical server cluster, and/or a cloud server. As shown in FIG. 1, the method may include operations 110 to 140.

In operation 110, the electronic device may obtain point cloud data. The point cloud data may include related information of a plurality of points. The related information may include at least one piece of three-dimensional (3D) coordinate information.

In operation 120, the electronic device may sort the plurality of points based on the 3D coordinate information of the plurality of points.

In operation 130, the electronic device may obtain feature information of the plurality of points using a CNN (e.g., a one-dimensional (1D) CNN), based on the related information of the plurality of sorted points.

In operation 140, the electronic device may process the point cloud data based on the feature information of the plurality of points.

The point cloud data may also be expressed as point cloud data to be processed. The method in which the electronic device obtains the point cloud data is not limited thereto. For example, the point cloud data may be point cloud data of a target scenario collected through one point cloud data collection method or a plurality of point cloud data collection methods. The target scenario may be any scenario.

The related information of each point of the point cloud data may further include at least one piece of attribute information of the points in addition to the 3D coordinate information of the points. The at least one piece of attribute information may include, for example, color information and/or reflection intensity information of the points.

The point cloud data may be captured by a detection apparatus (e.g., a 3D spatial scanning apparatus). For example, 3D point cloud data may be captured by light detection and ranging (LiDAR) and/or a red, green, and blue (RGB)-D sensor (e.g., including an RGB camera and a depth sensor).

The collection of the point cloud data may depend on the spatial distance between the detection apparatus and a detection target. The electronic device may accurately determine a 3D spatial coordinate (x, y, z) of a certain point of an object, using distance and direction information. In addition to the 3D spatial coordinate, other available information of each point may be recorded in the point cloud data.

For example, when the detection apparatus is or includes a LiDAR sensor, a pulse signal output from a pulse transmitter of the LiDAR sensor may be reflected back to a pulse receiver of the LiDAR sensor, and the reflection intensity i may be used as related information of a corresponding point. For example, when the detection apparatus is or includes an RGB-D sensor, RGB 3-channel values r, g, and b of an image pixel mapped to the positions of each point may also be recorded as the related information of the corresponding point. Accordingly, in the two cases described above, each point and the related information of the corresponding point may be recorded in a four-dimensional (4D) form of (x, y, z, i) (e.g., when the detection apparatus is or includes the LiDAR sensor) or a six-dimensional (6D) form of (x, y, z, r, g, b) (e.g., when the detection apparatus is or includes the RGB-D sensor).

The point cloud data may be understood as a data sample configured with the plurality of points. For example, when the point cloud data is collected by LiDAR, when there are a total of N points in the point cloud data, the point cloud may be stored in the 2D matrix form of P∈R^{(N×4)} of N×4 and be processed subsequently.

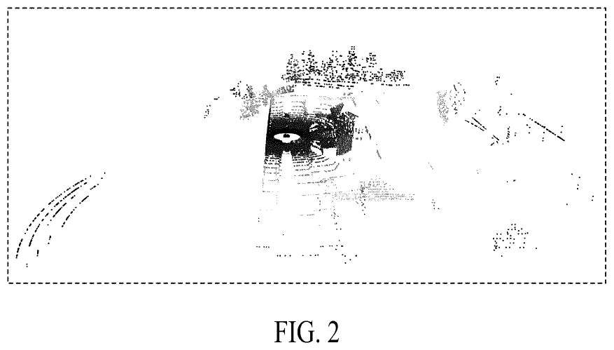

FIG. 2 illustrates an example of point cloud data of an outdoor scenario collected by LiDAR.

Referring to FIG. 2, the number of points of the point cloud data may be large, and the points of the point cloud data may be spatially loosely and unevenly distributed. Although not clearly shown in FIG. 2, related information of each point of the point cloud data may include a reflection intensity value of a corresponding point.

Unlike a 2D image, the point cloud data may be disordered and irregular. For example, the 2D image may generally be stored as a 2D matrix I∈R^{H×W} of H×W. Here, H and W denote the height and the width of an image, respectively, and the positions in which each pixel of the image is stored may all be fixed. That is, the form of the 2D matrix I may be sorted.

For example, a pixel of the j-th row and k-th column of the image may be stored at a (j, k) position of the 2D matrix I and may not be stored at any other position in a corresponding 2D matrix, and the positions of two different pixels may not be changed. In addition, images collected using the same image collection apparatus (e.g., a camera having the same parameter) may have the same size. For example, H and W may not be changed, and values of all pixels may be filled in the 2D matrix I in order. This may indicate that the form of the 2D matrix I is regular.

In contrast, in the case of point cloud data, assuming that the point cloud data collected by LiDAR is stored in the form of P∈R^{N×4}, a total of N points of a data sample may exist in a 3D space, and each row of P may represent 4D features (x, y, z, i) of one point. For example, for a certain point in the j-th row, although the certain point may be currently stored in the j-th row, when all pieces of related information of all N points are maintained, even when the certain point in the j-th row is moved to another row and stored in P, the point cloud data may not be changed. Accordingly, two different points indicated by any two rows may change row positions with each other. In addition, even when the same LiDAR is used, the sizes of N (e.g., the number of points) of the two collected point cloud samples may be different, and coordinate positions in which points may be placed may not be fixed but may be freely distributed in a space.

An AI network may generally require a sorted and regular input data form. Accordingly, processing the point cloud data using the AI network may include processing the point cloud data as relatively sorted and regular data prior to input to the AI network. An electronic device of one or more embodiments may sort a plurality of points of the point cloud data, based on 3D coordinate information of the plurality of points of the point cloud data, and sort pieces of related information of the plurality of points according to the result obtained by sorting the plurality of points. That is, the electronic device of one or more embodiments may regularize the point cloud data by sequentially arranging the pieces of related information of the plurality of points. The electronic device of one or more embodiments may then extract feature information of the plurality of points by applying the AI network, based on the sorted pieces of related information of the plurality of points. The electronic device may process the point cloud data based on the feature information of each point.

The electronic device may assign sorted positions to the points of the point cloud data by sorting points of point cloud data to be processed using a 3D coordinate. The sorted positions may be fixed positions that are not changed and may not be exchanged. The point cloud data may be considered as one sorted tensor (e.g., a 1D linear tensor), that is, a long series of densely arranged points.

The point cloud data in which the points are sorted may be expressed as a 1D linear tensor from the perspective of each channel by interpreting each item of the plurality of points as a channel. However, examples are not limited thereto, and the point cloud data may be expressed as a 2D tensor in terms of the point cloud data including records of the plurality of points and each record including item values of a plurality of items.

The electronic device may obtain features of each point of the point cloud data by extracting the features from the sorted pieces of point cloud data using an efficiently operating neural network structure (e.g., a 1D CNN). Here, an input of the neural network may be a tensor of sorted point clouds. The neural network may be used to extract the features based on the related information of each point among the sorted pieces of point cloud data. Finally, the understanding of the points may be realized based on the neural network.

The electronic device may reconstruct spatial information of the point cloud data without losing the related information of the points of the point cloud data and store the point cloud data in a certain form (e.g., a dense form). The electronic device of one or more embodiments may finally realize the understanding of the points by inputting the point cloud data in a certain form to a 1D AI network. The electronic device of one or more embodiments may obtain the sorted pieces of point cloud data in which related information of any point is not lost, through the reconstructing of the point cloud data. The related information of each point may be considered as a 1D initial feature vector of each point. Accordingly, the electronic device of one or more embodiments may extract the features from the reconstructed point cloud data using a 1D neural network. As a result, the electronic device of one or more embodiments may effectively improve the processing efficiency.

The electronic device of one or more embodiments may guarantee efficient processing without losing point cloud information, effectively improve the processing effect of the point cloud data, and satisfy the requirements in a practical application.

The 3D coordinate information of the points, such as the 3D spatial coordinate (x, y, z) described above, may reflect the spatial position of a corresponding point in the 3D space. Accordingly, by sorting the plurality of points based on the 3D coordinate information of the plurality of points of the point cloud data, the electronic device of one or more embodiments may ensure that adjacent points are still adjacent to each other in the 3D space when sorted, and the sorting result may reflect the positional relationship of the plurality of points of the point cloud data in the 3D space. As a result, the sorting of the points of the point cloud data may correspond to a real situation.

Here, the 3D coordinate information of each point among the plurality of points may include first coordinate values in a first dimension, second coordinate values in a second dimension, and third coordinate values in a third dimension of a corresponding point. Each of the first dimension, the second dimension, and the third dimension is not limited to which of the three dimensions each of the first dimension, the second dimension, and the third dimension corresponds. For example, the first dimension may correspond to an x-axis direction, a y-axis direction, or a z-axis direction. The second dimension may correspond to a direction that is different from the direction to which the first dimension corresponds. The third dimension may correspond to another direction other than the direction to which the first dimension corresponds and the direction to which the second dimension corresponds. The method in which the electronic device sorts the plurality of points based on the 3D coordinate information of the plurality of points is not limited thereto.

The electronic device may sort the plurality of points based on the spatial positional relationship between each point among the plurality of points. Here, the spatial positional relationship between each point may be based on the 3D coordinate information of the plurality of points. For example, the plurality of points may be sorted in the order of proximity according to the spatial positional relationship.

The electronic device may select one point having the smallest coordinate value or the largest coordinate value in a corresponding dimension as a sorted first point, based on a coordinate value in any dimension among pieces of 3D coordinate information, and then sort other points in the order of proximity to the selected one point according to the spatial positional relationship.

The electronic device may sort the plurality of points based on the 3D coordinate information of the plurality of points in the order in which the priority of the first coordinate values is the highest, the priority of the second coordinate values is the next highest, and the priority of the third coordinate values is the lowest.

The electronic device may sort the plurality of points based on the distance between the points of the plurality of points. For example, according to the distance between the points, two points that are closest to each other may be arranged at adjacent positions. The electronic device may determine, based on the plurality of points, the distance between a reference point and each unsorted point of the plurality of points until there are no unsorted points. The electronic device may determine, among the unsorted points, a point having the closest distance to the reference point as a point positioned next to the reference point.

The electronic device may repeat a sorting operation that determines the point having the smallest distance from the reference point as the point positioned next to the reference point. The reference point of a first sorting operation may be a starting point of the sorting. The starting point of the sorting may be one point selected from the plurality of points. The reference point of the sorting operation except for the first sorting operation may be a point determined to be positioned after the reference point of a previous sorting operation.

Here, the electronic device may select one of the plurality of points as the starting point. For example, the electronic device may select, as the starting point, among the plurality of points of the point cloud data, a point having the smallest first coordinate value, a point having the smallest second coordinate value, or a point having the smallest third coordinate value. The starting point may be the first point after sorting as the starting point from which the sorting starts. For example, the electronic device may select, as the starting point, among the plurality of points, a point having the largest first coordinate value, a point having the largest second coordinate value, or a point having the largest third coordinate value.

The electronic device may determine, to be a second point, among the remaining points, a point having the closest distance to the first point in response to determining the first point (e.g., the starting point), determine, to be a third point, among the remaining points excluding the first point and the second point, a point having the closest distance to the second point, and continue the process until all the points are sorted.

In a priority-based sorting method, when the order of two points is determined according to the first coordinate values of the two points (e.g., when the first coordinate values of the two points are different from each other), the electronic device may determine the order of the two points according to the first coordinate values. When it may not be determined whether one point is in the front and the other point is in the back according to the first coordinate values of the two points (e.g., when the first coordinate values of the two points are the same), the electronic device may sort the two points according to the second coordinate values of the two points. When the order of the two points is sorted according to the second coordinate values, the electronic device may determine the order of the two points according to the second coordinate values. When it may not be determined whether one point is in the front and the other point is in the back according to the second coordinate values of the two points (e.g., when the second coordinate values of the two points are the same), the electronic device may sort the order of the two points according to the third coordinate values of the two points. When it may not be determined whether one point is in the front and the other point is in the back according to the third coordinate values of the two points (e.g., when the third coordinate values of the two points are the same), the electronic device may determine the sorting position of the two points in the order in which one point (e.g., one point randomly selected from the two points) is in the front and the other point is in the back. However, the present disclosure is not limited thereto, and the order of the two points may be determined according to another sorting strategy.

The electronic device may sort the two points based on coordinate values in a reference dimension for a coordinate value (e.g., one of the first coordinate values, the second coordinate values, or the third coordinate values) in the reference dimension among the pieces of 3D coordinate information. For example, the electronic device may sort the two points based on the sizes of the coordinate values of the reference dimension of the two points. For example, the electronic device may sort the two points based on normalized coordinate values of the reference dimension of the two points.

When the order of the two points is determined based on the coordinate values of one dimension of the two points, the electronic device may determine the order of the two points according to the coordinate values of the two points or the normalized coordinate values of the two points.

For example, the electronic device may arrange a point having a smaller coordinate value than other coordinate values in the front (or arrange a point having a larger coordinate value than other coordinate values in the front) according to the comparison result of the coordinate values of the two points. For example, the electronic device may normalize each of the coordinate values of the two points, compare the normalized coordinate values of the two points, and arrange a point having a smaller normalized coordinate value than other normalized coordinate values in the front (or arrange a point having a larger normalized coordinate value than other normalized coordinate values in the front) according to the comparison result. In addition, when the difference between the coordinate values or the normalized coordinate values of the two points is less than a preset threshold value, the electronic device may determine (e.g., consider) that the coordinate values of the two points are the same in the reference dimension and may compare the coordinate values of the two points based on the coordinate values (or the normalized coordinate values) in other dimensions.

The electronic device may sort the first coordinate values according to the comparison result between normalized first coordinate values of the two points. When the order of the two points is not determined according to the normalized first coordinate values, the electronic device may sort the order of the two points according to the comparison result between normalized second coordinate values of the two points. When the order of the two points is not determined according to the normalized second coordinate values, the electronic device may sort the order of the two points according to the comparison result between normalized third coordinate values of the two points. When the normalized third coordinate values of the two points are the same, the electronic device may determine that the order of one (e.g., one point randomly selected from the two points) of the two points precedes the order of the other point and that the order of the other point follows the order of the one point.

The method of normalizing the coordinate values of each point in the point cloud data is not limited thereto. For example, the electronic device may normalize the coordinate values and/or perform an integer rounding up or down operation to normalize the coordinate values.

The electronic device may sort the plurality of points based on the 3D coordinate information of the plurality of points in the order in which the priority of the first coordinate values is the highest, the priority of the second coordinate values is the next highest, and the priority of the third coordinate values is the lowest.

For example, for the two points among the plurality of points, the electronic device may sort the two points based on the first coordinate values of the two points according to a first order when the first coordinate values of the two points do not satisfy a first condition. The first order may include an ascending order or a descending order.

The electronic device may sort the two points based on the second coordinate values of the two points according to the first order when the first coordinate values of the two points satisfy the first condition and the second coordinate values of the two points do not satisfy a second condition.

The electronic device may sort the two points based on the third coordinate values of the two points in the first order when the first coordinate values of the two points satisfy the first condition and the second coordinate values of the two points satisfy the second condition.

The first condition may include a condition used to determine whether the first coordinate values of the two points are the same. The second condition may include a condition used to determine whether the second coordinate values of the two points are the same. The details of the first condition and/or the second condition may be set according to the actual requirements. The determination reference of the first condition and the second condition may be the same or different.

For example, the first condition may include at least one of the fact that the first coordinate values of the two points are the same, the fact that the normalized first coordinate values of the two points are the same, the fact that a difference value of the first coordinate values of the two points is less than or equal to a first threshold value, or the fact that a difference value of the normalized first coordinate values of the two points is less than or equal to a second threshold value.

For example, the second condition may include at least one of the fact that the second coordinate values of the two points are the same, the fact that the normalized second coordinate values of the two points are the same, the fact that a difference value of the second coordinate values of the two points is less than or equal to a third threshold value, or the fact that a difference value of the normalized second coordinate values of the two points is less than or equal to a fourth threshold value.

At least two of the first threshold value, the second threshold value, the third threshold value, or the fourth threshold value may be the same or different.

The electronic device may normalize at least one of the first coordinate values, the second coordinate values, or the third coordinate values. For example, the electronic device may obtain a second value by dividing at least one coordinate value by a set first value. The electronic device may obtain a normalized coordinate value corresponding to at least one coordinate value by performing an integer rounding up or down operation on the obtained second value.

The first value may be less than the first coordinate values. The electronic device may process each coordinate value of the 3D coordinate information as an integer using the first value that is less than the first coordinate values and may normalize each coordinate value of each dimension of the points of the point cloud data. According to the size of each normalized coordinate value, the electronic device may sort the plurality of points in ascending order of the coordinate values, based on the principle in which the priority of the first coordinate values (e.g., the first normalized coordinate values) is the highest, the priority of the second coordinate values (e.g., the second normalized coordinate values) is the next highest, and the priority of the third coordinate values (e.g., the third normalized coordinate values) is the lowest.

The first values for each dimension may be the same or different. The methods (e.g., the methods of normalizing the coordinate values for each dimension) of taking an integer corresponding to a coordinate value for each dimension may be the same or different.

The electronic device may determine the order of the plurality of points according to the coordinate values of at least one dimension of the plurality of points or the distance between the points and then obtain the features of each point by extracting the features of the plurality of points through the 1D CNN, based on the pieces of related information of the plurality of points that are obtained and sorted.

The network structure of the 1D CNN is not limited thereto. For example, the 1D CNN may include at least one 1D convolution module. For example, the 1D CNN may include a plurality of cascaded 1D convolution modules. One 1D convolution module may include at least one convolution layer.

An input of a first 1D convolution module of a 1D convolution network may include the related information of the plurality of sorted points. An input of a 1D convolution module that is different from that of the first 1D convolution module may include at least one of the features of the plurality of points in response to sorting the features of the plurality of points output from a previous 1D convolution module, based on the features of the plurality of points output from the previous 1D convolution module or the re-sorted order of the plurality of points.

For example, an input of other 1D convolution modules except for the first 1D convolution module may be an output of a previous convolution module or a feature obtained after re-sorting the features of each point output from the previous convolution module.

A feature sorting module may be connected between adjacent 1D convolution modules. The electronic device may re-sort the plurality of points through the feature sorting module, based on the 3D coordinate information of the plurality of points. The electronic device may sort the features of the plurality of points output from the previous 1D convolution module according to the order of the plurality of re-sorted points and may then input the features of the plurality of points to the next 1D convolution module.

The electronic device may re-sort the plurality of points based on the 3D coordinate of the plurality of points using the feature sorting module, sort the features of the plurality of points output from the previous 1D convolution module according to the order of the plurality of re-sorted points, and then input the features of the plurality of points to the next 1D convolution module.

When the electronic device sorts the plurality of points multiple times based on the 3D coordinate information of the plurality of points, the sorting methods in at least two pieces of sorting may be different from each other in the multiple sorting, and/or the network structures of at least two 1D convolution modules may be different from each other.

By using various sorting methods and/or various network structures, the point cloud data may be better understood in various dimensions, and the expressiveness of the obtained point features and the processing effect of the point cloud data may be improved. The difference in the network structures of the 1D convolution module may include, but is not limited thereto, the difference in the number of convolution layers included in the convolution module and/or the sizes of convolution kernels of the convolution layer.

The 1D convolution module may include a cascaded 1D channel mixture layer and a 1D spatial mixture layer. Based on an input of the 1D convolution module, an output of the 1D convolution module may be obtained by obtaining first features of each point by performing a convolution on features of a plurality of channels of each point of inputs using a channel mixture layer and by obtaining second features of each point by performing a convolution on features of the same channel of the first features of associated points corresponding to each point using a spatial mixture layer, based on the first features of the plurality of points output from the channel mixture layer.

The associated points corresponding to a certain point may include at least one adjacent point that is adjacent to a certain point among the plurality of points and certain points.

The electronic device may perform a cross-channel operation on the features of each point using the channel mixture layer. Since the points are independent from each other, an operation for extracting the features of the points themselves may be trained in the channel mixture layer. The electronic device may interact with information of the same channel between the points through a channel-wise convolution using the spatial mixture layer, and since adjacent points are usually arranged together when sorting the points, an operation for extracting local features between the adjacent points may be trained in the spatial mixture layer. Accordingly, the electronic device may obtain the feature information of each point having better feature expressiveness than the feature expressiveness of the features obtained through a comparative example, using the channel mixture layer and the spatial mixture layer.

The point cloud data (e.g., the point cloud data to be processed) may be point cloud data of a target scenario collected at a first time point. In a practical application, scenario information included in the point cloud data of a single time frame (e.g., a certain time point) may not be comprehensive. For example, the point cloud data of the single time frame may include at least a partially occluded area and/or may lack motion information of an object of a scenario.

The electronic device may obtain associated point cloud data. The associated point cloud data may include point cloud data collected before the first time point and/or point cloud data collected after the first time point. In sorting the plurality of points based on the 3D coordinate information of the plurality of points. The electronic device may sort first group points and second group points, based on 3D coordinate information of the first group points and 3D coordinate information of the second group points. The first group points may include the plurality of points of the point cloud data, and the second group points may include the plurality of points of the associated point cloud data.

Based on the related information of the plurality of sorted points, in obtaining the feature information of the plurality of points using the 1D CNN, the electronic device may obtain the feature information of each point among the first group points and the second group points using the 1D CNN, based on the sorted first group points and the sorted second group points. The electronic device may obtain the feature information of each point of the point cloud data at multiple time points, based on point cloud data at multiple time points. The electronic device may improve the expressiveness of the point features using the feature information of each point of the point cloud data at multiple time points.

In processing the point cloud data based on the feature information of the plurality of points, the electronic device may process the point cloud data based on the feature information of the first group points. In processing the point cloud data based on the feature information of the plurality of points, the electronic device may process the point cloud data and the associated point cloud data, based on the feature information of the first group points and the feature information of the second group points.

The associated point cloud data may include the point cloud data of the single time frame or multiple time frames. For example, the associated point cloud data may include point cloud data of the target scenario collected at the time point before the first time point, point cloud data collected at the time point before the previous time point, or point cloud data collected at the time point after the first time point.

The electronic device may obtain features having richer semantic information by supplementing insufficient information in the point cloud data to be processed using the associated point cloud data.

In response to obtaining the feature information of each point of the point cloud data to be processed, in processing the point cloud data based on the feature information of the plurality of points, the electronic device may perform corresponding processing on the point cloud data, based on the feature information of each point of the point cloud data according to a point cloud processing task. In response to obtaining the feature information of each point of the point cloud data to be processed, in processing the point cloud data based on the feature information of the plurality of points, the electronic device may process the point cloud data and the associated point cloud data according to the feature information of each point of the point cloud data and the associated point cloud data according to the point cloud processing task.

The point cloud processing task may be any processing task based on the point cloud data. For example, the point cloud processing task may include, but is not limited thereto, point cloud division (e.g., classifying the points of a point cloud), point cloud detection (e.g., detecting a target and/or an object among scenarios corresponding to the point cloud data), scenario reconstruction, etc.

A solution is provided in combination with optional examples to better describe the device and the method.

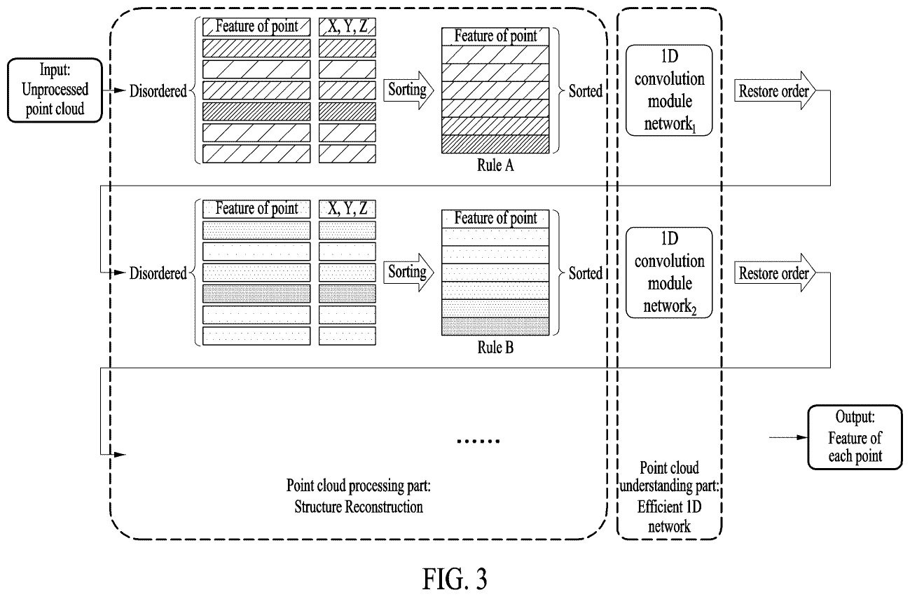

FIG. 3 illustrates an example of an AI-based point cloud data processing method.

As shown in FIG. 3, a point cloud data processing method may include two parts. One may be a point cloud processing part and the other may be expressed as a point cloud understanding part.

The point cloud processing part may include determining a sorting method, sorting points of a point cloud sample (e.g., point cloud data to be processed) in a 3D coordinate, regularizing point clouds based on the sorting result, and/or reconstructing point cloud data. The entire sorted point cloud may be understood as one sorted 1D linear tensor, that is, a long series of densely arranged points.

The point cloud understanding part may be configured as a 1D neural network structure that is executed efficiently. An input of the 1D neural network may be a tensor of sorted pieces of point cloud data. The 1D neural network may be used to finally understand the point cloud by continuously extracting features through a 1D convolution.

Referring to FIG. 3, each long rectangle (e.g., “Feature of point”) may represent features of each point of the point cloud, the short rectangle on the right (e.g., “X, Y, Z”) may represent a 3D coordinate (x, y, z) of each point, and here, x, y, and z may represent an x-axis coordinate value, a y-axis coordinate value, and a z-axis coordinate value of each point. The features of each point of the point cloud may be a vector in which the number of channels that record information of a corresponding point is C. Before the feature of each point are input to the 1D neural network, the features of each point may be related information of one point, and the related information may include at least one piece of 3D coordinate information of the corresponding point, and optionally, the related information may further include at least one piece of attribute information of the corresponding point.

For example, when the related information of each point includes the 3D coordinate information and at least one piece of attribute information of the corresponding point, the number of channels of the features may be the sum of 3 and the number of attribute information items, and coordinate values of each dimension may be features of one channel, and attribute values of the attribute information items may be features of one channel. For example, in the case of point cloud data collected based on LIDAR, C=4 may record each of x, y, z, and i, and i may represent the reflection intensity. Optionally, as the points are input to a neural network, the number of channels C of the features of the points output from a convolution module of the neural network may increase. The increase in the value of the number of channels may indicate that more information is trained, so the understanding of the point cloud is achieved.

A 1D CNN may include at least one 1D convolution module. For example, as shown in FIG. 3, the 1D CNN may include a plurality of 1D convolution modules. The 1D CNN may include a first 1D convolution module network₁, a second 1D convolution module network₂, and a 1D convolution module that is unillustrated and indicated by an ellipsis.

For example, when the number of points included in the point cloud data to be processed is N, the point cloud data to be processed may be stored in a disorderly manner. Before sorting and the application of a first layer of a network, all points may be arranged in no order. Here, even when the features of a certain point are moved sequentially or the order thereof is changed with other points, the point cloud expression may not be affected.

An electronic device may determine a sorting rule order₁ (e.g., rule A), based on a 3D space coordinate of a point in the first layer of the neural network, and may sort N points of the point cloud data. Through the sorting of the points, the electronic device may store all features of each point in a fixed position. For example, in the sorted points, a point in the first row may be disposed only in the first row and may not be randomly moved or exchanged. As shown in FIG. 3, all points may form a tensor when sorted, the length of the tensor may be N, and the features of each point in the tensor may include the features of C channels.

Sorted pieces of data may be transmitted to the 1D convolution module network₁ including a 1D convolution for feature operation and extraction. The 1D convolution module may include a 1D convolution of which a convolution kernel is k, and the electronic device, in the 1D convolution module, may cross-extract local features by interacting information with other points that are adjacent to the corresponding point with respect to each point.

After an operation is completed in the 1D convolution module network₁, the electronic device may input the features of each point output from the 1D convolution module network to the next 1D convolution module network₂. When an operation is completed in the 1D convolution module network₁, the electronic device may restore the points of the point cloud data to the order before sorting, re-sort the plurality of points of the point cloud data, sort the features of each point output from the 1D convolution module network₁ according to the sorting result, and input the features of each sorted point to the next layer network₂. As shown in FIG. 3, in response to sorting the points in a sorting rule order₂ (e.g., rule B) according to the 3D space coordinate of each point in the point cloud data, the electronic device may adjust the features of each point output from the 1D convolution module network₁ according to the order of each sorted point and may input the adjusted features of each point to the second 1D convolution module network₂.

The electronic device may perform a similar task from a second layer to the last layer of the neural network, but the sorting algorithm configurations of each layer may be different. For example, the network modules (e.g., the 1D convolution modules) of each layer may be configured independently from each other. There may be differences between order₂ and order₁ and between network₂ and network₁. The point cloud may be better understood through different orders and network configurations.

Hereinafter, two sorting methods provided herein are described as examples to illustrate optional implementation methods of the sorting methods. It should be noted that these two sorting methods are not limited to the examples described herein. Theoretically, the method of sorting the points of point cloud according to the spatial positional relationship between the points of the point cloud data may be included in the optional implementation methods of the sorting methods provided herein.

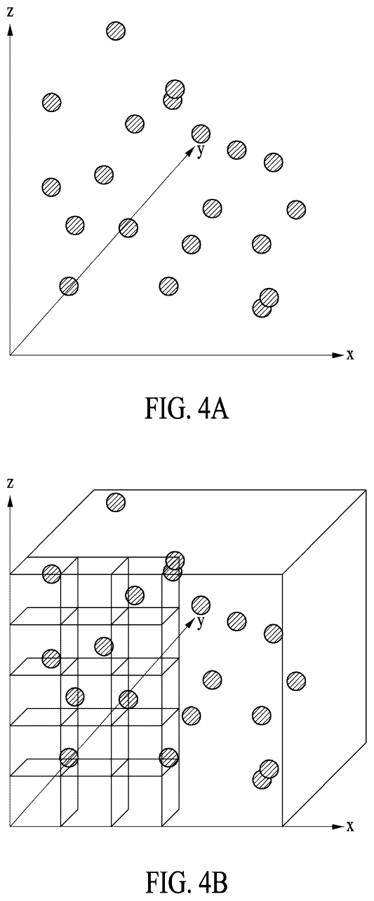

FIGS. 4A and 4B illustrate examples of sorting pieces of point cloud data according to a first sorting method.

In FIG. 4A, the positions of each point in a 3D coordinate system may be 3D coordinate information of a corresponding point and may include an x-axis coordinate value, a y-axis coordinate value, and a z-axis coordinate value.

An electronic device may divide a 3D space into voxels through a space division method (e.g., voxelization). For example, the electronic device may divide the 3D space into small cubes of which the side length is Δx×Δy×Δz. For example, the electronic device may determine the boundary of the 3D space such as the maximum coordinate value and the minimum coordinate value in three directions (e.g., an x-axis direction, a y-axis direction, and a z-axis direction) of point cloud data. The electronic device may obtain a cubic form surrounding all points of the point cloud data by determining the determined boundary to be the boundary of the cubic form. As a result, all points of the point cloud data may be in the cubic form. The electronic device may then divide the cubic form into small cubes having a size of Δx×Δy×Δz. The small cube may also be represented as a voxel. Each point may exist in a unique voxel, and here, Δx, Δy, and Δz may represent the length of the side in the x-axis direction, the length of the side in the y-axis direction, and the length of the side in the z-axis direction of the small cube, respectively. That is, a first value may include Δx, Δy, and Δz. Δx may represent a first value corresponding to a first dimension. Δy may represent a first value corresponding to a second dimension. Δz may represent a first value corresponding to a third dimension.

Assuming that the actual 3D coordinate of a point pᵢ of the point cloud data is (xᵢ, yᵢ, zᵢ), a coordinate

$${grid}_{i , x} = ⌊ \frac{{x}_{i}}{Δ x} ⌋ , {grid}_{i , y} = ⌊ \frac{{y}_{i}}{Δ y} ⌋ , {grid}_{i , z} = ⌊ \frac{{z}_{i}}{Δ z} ⌋$$

of a voxel in which the point pᵢ is positioned may be determined, and here, └.┘ may represent an integer rounding-down operation. The electronic device may sort the points through a coordinate (grid_{i,x}, grid_{i,y}, grid_{i,z}) of the voxel and/or the 3D coordinate (xᵢ, yᵢ, zᵢ).

For example, the electronic device may ensure that a point having a smaller grid_{i,x} is in front of a point having a larger grid_{i,x} by comparing grid_{i,x} of all points, ensure that a point having a smaller grid_{i,y} is in front of a point having a larger grid_{i,y} by comparing grid_{i,y} of points having the same grid_{i,x}, and finally sort all points by comparing zᵢ of points having the same grid_{i,y}.

The sorting method described above may be understood as essentially dividing the space in which the points of the point cloud data are included into several columns on the x-axis and the y-axis. The sorting method described above may include sorting the points based on coordinate values in the z-axis direction in each column and sorting the points based on gridₓ and grid_{y} between the columns. As a result, adjacent points in the z-axis may still be adjacent to each other when sorted. The reference of the sorting method described above may be grid_{i,x}, grid_{i,y}, and zᵢ, sequentially. Similarly, five other sorting methods may be configured. The references of the five sorting methods may be grid_{i,y}, grid_{i,z}, xᵢ; grid_{i,z}, grid_{i,x}, yᵢ, grid_{i,x}, grid_{i,z}, yᵢ, grid_{i,y}, grid_{i,x}, zᵢ; grid_{i,z}, grid_{i,y}, and xᵢ. Optionally, the six sorting methods may be used periodically in various layers of a network.

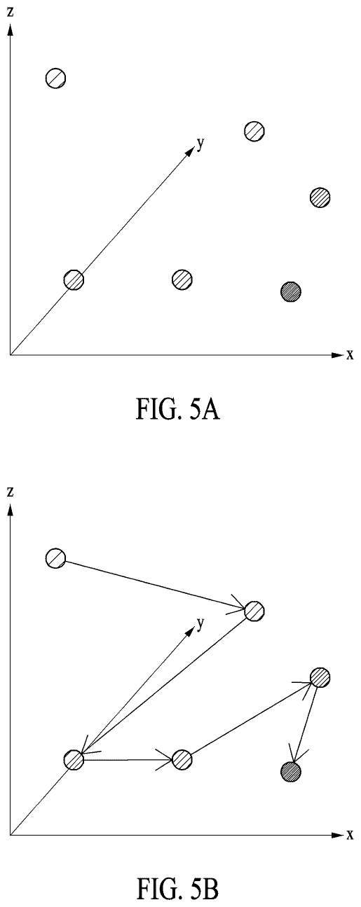

FIGS. 5A and 5B illustrate examples of sorting pieces of point cloud data according to a second sorting method.

An electronic device may select a starting point p₀ (e.g., a point on a y-axis in FIGS. 5A and 5B) from point cloud data. The electronic device may select, among a plurality of points, as the starting point p₀, a point having the smallest coordinate value (e.g., a coordinate value on the x-axis, a coordinate value on the y-axis, or a coordinate value on the z-axis) on a certain axis. The electronic device may determine a first point p₁ that is spatially closest to the starting point p₀ starting from the starting point p₀. The electronic device may determine a second point p₂ that is spatially closest to the first point p₁. The electronic device may repeat determining the closest point from a certain point until the order of all points of the point cloud data is determined. The electronic device may sort the points in the determined order.

The electronic device may sort pieces of related information (e.g., the features of C channels) of the plurality of points in the order of the points, based on the determining of the order of the plurality of points of the point cloud data. When the point cloud data includes N points, the features of sorted point clouds may be a tensor having the length of N and the number of channels of C. The electronic device may obtain the features (e.g., the output of FIG. 3) of each point of the point cloud data by processing the tensor (e.g., the features of the sorted point clouds) using a 1D CNN.

Hereinafter, an example of the network structure of the 1D CNN provided herein is described in combination with optional implementation methods. The 1D CNN may include at least one 1D convolution module. The 1D CNN may use a plurality of cascaded 1D convolution modules to extract feature information of each point with richer information.

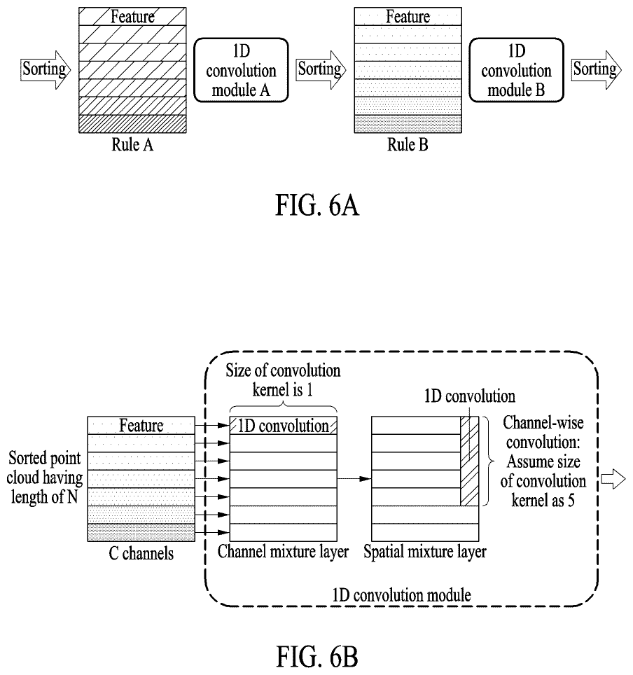

FIGS. 6A and 6B illustrate examples of a 1D convolution module.

An input of the 1D convolution module may include sorted point cloud features. It may be assumed that the input of the 1D convolution module is a tensor having the length of N and the number of channels of C. By generating an input processable by the 1D convolution module, the electronic device of one or more embodiments may implement a network structure of a neural network that does not require a complex network structure (e.g., an attention mechanism or a transformer), thereby reducing computation costs. The electronic device of one or more embodiments may use the 1D CNN for point cloud understanding based only on simple and efficient 1D convolution.

FIG. 6A illustrates the data processing principle of the first two 1D convolution modules of the neural network. For example, a 1D convolution module A and a 1D convolution module B of FIG. 6A may be network₁ and network₂ of FIG. 3A, respectively.

Here, an input of the 1D convolution module A may be a tensor obtained as a result of sorting the pieces of point cloud data one time. For example, as shown in FIG. 6A, the input of the 1D convolution module A may be point cloud features obtained by sorting the pieces of point cloud data according to a sorting rule A. An electronic device may extract features of the point cloud data using the 1D convolution module A to obtain the features of each sorted point.

The electronic device may re-sort (e.g., sort features according to a sorting rule B) features of the plurality of points output from the 1D convolution module A. The electronic device may obtain an output of the 1D convolution module B by inputting the re-sorted features of the plurality of points to the 1D convolution module B. In the electronic device, the output of the 1D convolution module B may be re-sorted. Although not clearly shown in FIG. 6A, the electronic device may then extract the features of the points by inputting the sorted output of the 1D convolution module B to another 1D convolution module (not shown) again. The electronic device may obtain an output (e.g., an output of a CNN) of the last 1D convolution module by sorting the plurality of points and extracting the features multiple times, based on the sorted features of the points. Here, the output of a CNN may be a tensor. Each row of the tensor may be features (e.g., feature vectors) of one point. The order of the features of one point in the output tensor may be the same as the order of a corresponding point resulting from the last sorting prior to input. That is, the first row of the output tensor may be feature information of a first point resulting from the last sorting and the second row of the tensor may be feature information of a second point resulting from the last sorting.

FIG. 6B shows an optional network structure of the 1D convolution module. As shown in FIG. 6B, the network structure of the 1D convolution module may include a channel mixture layer and a spatial mixture layer.

The electronic device may perform a cross-channel operation on the features of each point with a convolution in which the size of a convolution kernel is 1 (e.g., 1*C) through the channel mixture layer. The electronic device may better train the features of the points themselves using the channel mixture layer.

There may be several convolution kernels of the channel mixture layer, and the correlation between features of different channels of the points themselves may be trained in different dimensions.

The electronic device may interact with local features of adjacent points in a space using the spatial mixture layer. The size of a convolution kernel of the spatial mixture layer may be k (k*1). Through the spatial mixture layer, information between the points may be interacted using a channel-wise convolution (e.g., a depth-wise convolution). When the electronic device arranges adjacent points adjacently in the sorting process, the local features of the adjacent points may be interacted in a space. There may be several convolution kernels of the spatial mixture layer. A certain channel may correspond to a certain convolution kernel.

The CNN may finally output the features of each point. That is, the output of the CNN may include the tensor having the length of N and the number of channels of C (e.g., the number of channels of the tensor and the number of channels of an input tensor of the neural network may be the same or different). Each row of the tensor may represent the features of one point. The electronic device may complete a task, such as cloud detection or division, based on the features through a downstream task.

Hereinafter, optional implementation methods for understanding the point cloud are described based on multi-frame point cloud data provided herein.

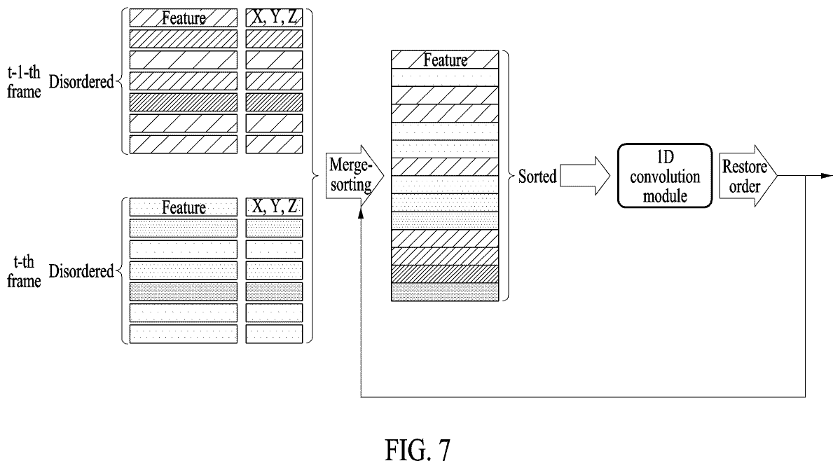

FIG. 7 illustrates an example of understanding a point cloud data, based on a multi-time frame.

Referring to FIG. 7, point cloud data Pₜ (e.g., point cloud data to be processed and data of a t-th frame of FIG. 7) collected at a time point t may include N points. Both processing and understanding of the point cloud data Pₜ may be performed according to various examples described above.

Point cloud data Pₜ₋₁ (e.g., associated point cloud data and data of a t−1-th frame of FIG. 7) collected at a previous time point t−1 may include M points. An electronic device may further consider information of the point cloud data Pₜ₋₁ when the point cloud data Pₜ is processed and understood. For reference, as described above, the point cloud data of the single time frame may include at least a partially occluded area or may have insufficient motion information. The electronic device may supplement the meaning of the single time frame by processing point clouds of a plurality of time frames together. When associated point clouds of the plurality of time frames are processed together, the electronic device of one or more embodiments may advantageously remove shielding that may exist in the point clouds of the single time frame using knowledge related to the order. The point clouds may be better understood based on the temporal fusion of feature(s) of the point clouds through feature fusion of the plurality of time frames.

Referring to FIG. 7, when sorting N points of the point cloud data Pₜ at a time point, the electronic device may add M points of the point cloud data Pₜ₋₁ at a previous time point and sort the M points of the point cloud data Pₜ₋₁ at the previous time point together. The electronic device may obtain a 1D linear tensor having a length of M+N. The electronic device may input the obtained 1D linear tensor to the CNN. For example, the electronic device may obtain features of the M+N points by extracting and/or determining the features using at least one cascaded 1D convolution module from the obtained 1D linear tensor.

For example, FIG. 7 illustrates the 1D linear tensor having a length of M+N as the features as result of merge-sorting. Each row of the 1D linear tensor may represent pieces of channel information of one point. An input of a first 1D convolution module may include sorted pieces of related information of the M+N points. The related information of each point may include data of one row of the 1D linear tensor. An input of a second 1D convolution module may include the features of the M+N points output from the first 1D convolution module. Alternatively, the input of the second 1D convolution module may include the features of the M+N points obtained by sorting the features of the M+N points output from the first 1D convolution module according to the re-sorting result of the M+N points.

The electronic device may perform a downstream task based on features of N points of the point cloud data Pₜ. However, the present disclosure is not limited thereto, and the electronic device may also perform the downstream task based on the features of the M+N points.

The method and/or the device may be applied to all applications based on the point cloud data. For example, an application based on the point cloud data may include any point cloud task such as point cloud division, point cloud detection, point cloud tracking, point cloud registration, etc.

The method and/or device may be used in an autonomous driving system or a robot system. The method and/or device may be used to implement a portable module of an autonomous driving system or a robot system, and the implemented module may process the point cloud data by executing the methods.

The point cloud data processed by the method and/or device may be any point cloud data. For example, the point cloud data may include, but is not limited thereto, point cloud data collected based on LiDAR, point cloud data collected based on an RGB-D sensor, etc.

Non-limiting examples of the beneficial effects of the method and/or device may be as follows.

The electronic device may reconstruct the point cloud data structure by sorting the points. The sorted points may be normalized into a 1D structure. By the sorting of the points of a point cloud disclosed herein, the electronic device of one or more embodiments may maintain information about all points, prevent losing information, and sort the points at high speed.

The electronic device may use an efficient 1D convolutional network to understand the point cloud. An input of a 1D convolutional network may include point cloud expression through the sorted points. The point cloud may be understood using the 1D convolutional network including at least one 1D convolution module and sorted pieces of input data. The 1D convolutional network implemented by the electronic device of one or more embodiments may have a simple structure, be easy to implement, and have high processing efficiency.

The electronic device of one or more embodiments may process the downstream task based on the point cloud data with high precision.

The task of dividing (e.g., classifying the points) the point cloud is tested in a validation set of a SemanticKITTI data set (e.g., an authoritative data set in the field of autonomous driving) to verify the effectiveness of the electronic device and/or the method performed by the electronic device. As a result of the test, the electronic device and/or the method performed by the electronic device of one or more embodiments may outperform a typical electronic device and/or method in both sample division time and accuracy.

The electronic device may include a processor. The electronic device may further include a transceiver and/or a memory coupled to the processor. The processor of the electronic device may be configured to execute instructions corresponding to some methods or all methods.

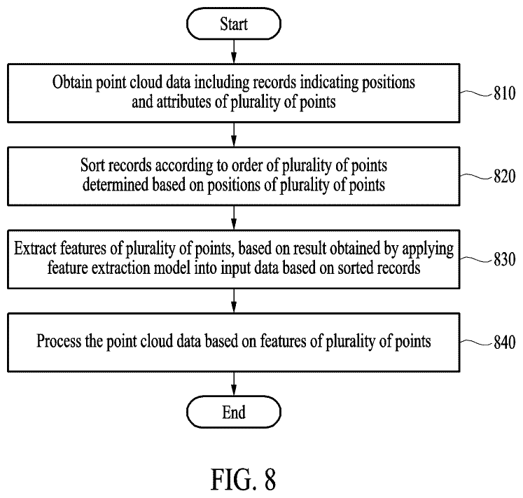

FIG. 8 illustrates an example of a method, performed by an electronic device, of processing point cloud data. Operations 810 to 840 to be described hereinafter may be performed sequentially in the order and manner as shown and described below with reference to FIG. 8, but the order of one or more of the operations may be changed, one or more of the operations may be omitted, and two or more of the operations may be performed in parallel or simultaneously without departing from the spirit and scope of the example embodiments described herein.

The electronic device may extract features of a plurality of points from the point cloud data for the plurality of points and process the point cloud data based on the extracted features.

In operation 810, the electronic device may obtain the point cloud data. The point cloud data is a data structure that stores information about a point cloud and may include records indicating positions and attributes of the plurality of points. The point cloud may refer to a set (hereinafter, also referred to as a point set) of the points disposed in a 3D space.

The point cloud data may include records respectively corresponding to the plurality of points. For example, the records of the point cloud data may correspond one-to-one to the plurality of points.

Each record of the point cloud data may include item values of a plurality of items including a position item and an attribute item. The position item may refer to an item indicating the positions of the points. The attribute item may refer to an item indicating attributes of the points. The attribute item may include at least one color item or reflection intensity item. The color item may include color components (e.g., an R component(s), a G component(s), and a B component(s)) of light (e.g., visible light) reflected from the points. The reflection intensity item may refer to an item indicating the intensity from which a signal (e.g., a pulse signal) output from a pulse transmitter of LiDAR is reflected. However, the present disclosure is not limited thereto, and the attribute item may include a brightness item indicating the brightness of the points, a texture item indicating the texture of the points, a temperature item indicating the temperature of the points, etc.

The item value of the position item may include coordinate values of a plurality of coordinate axis directions. The plurality of coordinate axis directions may include coordinate axis directions according to an orthogonal coordinate system of the 3D space, for example, an x-axis direction, a y-axis direction, and a z-axis direction.

In operation 820, the electronic device may sort the records according to the order of the plurality of points determined based on the positions of the plurality of points.

The electronic device may determine the order of the plurality of points, based on priorities assigned to the plurality of coordinate axis directions. For example, the coordinate axis directions may include the x-axis direction, the y-axis direction, and the z-axis direction. A first priority may be assigned to the x-axis direction, a second priority may be assigned to the y-axis direction, and a third priority may be assigned to the z-axis direction. The first priority may be higher than the second priority, and the second priority may be higher than the third priority.

When the order between two points is determined, the electronic device may determine the sequentiality of the order of the two points, based on the size relationship between the coordinate values in the x-axis direction between the two points. When the size relationship between the coordinate values in the x-axis direction may not be determined (e.g., when the coordinate values in the x-axis direction are the same), the electronic device may compare the coordinate values in the y-axis direction having the highest priority other than the x-axis direction. Similarly, when the sequentiality of the order of the two points may be determined based on the size relationship between the coordinate values in the y-axis direction and when the size relationship between the coordinate values in the y-axis direction may not be determined (e.g., when the coordinate values in the y-axis direction are the same), the electronic device may compare the coordinate values in the z-axis direction having the highest priority other than the x-axis direction and the y-axis direction.

In comparing the coordinate values, the electronic device may determine (e.g., consider) that there is no difference between the coordinate values in a first coordinate axis direction between the two points, based on the difference between the coordinate values in the first coordinate axis direction between the two points being less than or equal to a threshold value.

When the electronic device compares the coordinate values of the points, although the direct comparison of the coordinate values is mainly described, the present disclosure is not limited thereto. For example, instead of the coordinate values of the points, the electronic device may compare values (e.g., quotients) obtained by dividing the coordinate values of the points by a predetermined value. The predetermined value used to divide the coordinate values may be independently determined for each coordinate axis direction.

The electronic device may compare, among the plurality of coordinate axis directions, the coordinate values when comparing the coordinate values in at least one coordinate axis direction and may compare, instead of the coordinate values, the values obtained by dividing the coordinate values by the predetermined value when comparing the coordinate values in other coordinate axis directions.

The electronic device may determine the order of the plurality of points based on the distance from a reference point. For example, the electronic device may select the reference point from among the plurality of points. The electronic device may determine, to be the reference point, among the plurality of points, a point having the smallest coordinate value or the largest coordinate value of a certain coordinate axis. The electronic device may randomly select the reference point from among the plurality of points. The electronic device may determine, among points of which the order is not determined among the plurality of points, the order of a target point that is closest to the reference point to be the next order of the reference point. The electronic device may repeatedly update the target point to the reference point and repeatedly determine the order of the target point, based on the updated reference point until the order of the plurality of points is determined.

In operation 830, the electronic device may extract features of the plurality of points, based on a result obtained by applying a feature extraction model to input data based on the sorted records.

The feature extraction model may refer to a model generated and/or trained to output the features of the plurality of points from the input data, based on the records of the plurality of points. The feature extraction model may be implemented based on a machine learning model (e.g., a CNN).

The feature extraction model may include a 1D CNN including a 1D convolution operation. The 1D convolution operation may refer to determining a convolution with an input while sliding a kernel, which is a 1D tensor, along one axis. The 1D tensor may be expressed as a vector having a size of 1*N (e.g., N is a natural number that is greater than or equal to 2) as a vector including elements arranged along one axis.

The electronic device may obtain, using each item of the sorted records as one channel, the input data including the sorted records with a plurality of channels. The input data may be used as an input of the feature extraction model.

The feature extraction model may include a plurality of convolution modules. For example, the feature extraction model may include a first convolution module including a 1D convolution operation and a second convolution module including a 1D convolution operation. Each convolution module may include at least one convolution layer.

The electronic device may determine a first order of the plurality of points according to a first reference assigned to the first convolution module. The electronic device may sort the records according to the first order. The electronic device may obtain intermediate features of the plurality of points, based on the result obtained by applying the first convolution module to first input data, based on the records sorted in the first order. The electronic device may obtain the features of the plurality of points based on the result obtained by applying the second convolution module to second input data, based on the output intermediate features.

The intermediate features may be sorted in a second order that is different from the first order. For example, the electronic device may determine the second order of the plurality of points according to a second reference assigned to the second convolution module. The electronic device may sort the intermediate features in the second order. The electronic device may apply the second convolution module to the second input data, based on the intermediate features sorted in the second order.

The feature extraction model may include a channel-wise convolution and a point-wise convolution. For example, the feature extraction model may include a first convolution layer and a second convolution layer. The first convolution layer may include determining a 1D convolution of a first kernel and the input data while sliding the first kernel, which is the 1D tensor, along an item axis of the input data. The second convolution layer may include determining a 1D convolution of a second kernel and the input data while sliding the second kernel, which is a 1D tensor, along a point axis of the input data.

For example, in the first convolution layer, the electronic device may determine the 1D convolution of the first kernel and the input data while sliding the first kernel, which is the 1D tensor, along the item axis of the input data. The electronic device may extract item mixture features indicating features based on item values of items for each point, based on the 1D convolution determined in the first convolution layer. In the second convolution layer, the electronic device may determine the 1D convolution of the second kernel and the input data while sliding the second kernel, which is the 1D tensor, along the point axis of the input data. The electronic device may extract spatial mixture features indicating features between each point and an adjacent point that is adjacent to a corresponding point, based on the 1D convolution determined in the second convolution layer.

In operation 840, the electronic device may process the point cloud data based on the features of the plurality of points.

For example, the electronic device may divide the plurality of points into a plurality of partial point sets by classifying the plurality of points, based on the features of the plurality of points.

For example, in operation 840, the electronic device may determine an object corresponding to at least one point, based on the features of the plurality of points.

The electronic device may process primary point cloud data using other pieces of point cloud data (hereinafter, also referred to as secondary point cloud data) collected at a time point that is similar to the time point of collection of the point cloud data to be processed (hereinafter, also referred to as primary point cloud data).

The electronic device may obtain the primary point cloud data corresponding to a first time point. The electronic device may obtain the secondary point cloud data corresponding to a second time point that is temporally adjacent to the first time point.

The electronic device may determine the order of points in the entire point set including first points of the primary point cloud data and second points of the secondary point cloud data. The electronic device may sort records of the primary point cloud data and records of the secondary point cloud data according to the determined order of the points in the entire point set.

The electronic device may obtain features of the points in the entire point set using the feature extraction model. The electronic device may process the primary point cloud data using features of the first points among the features of the points in the entire point set.

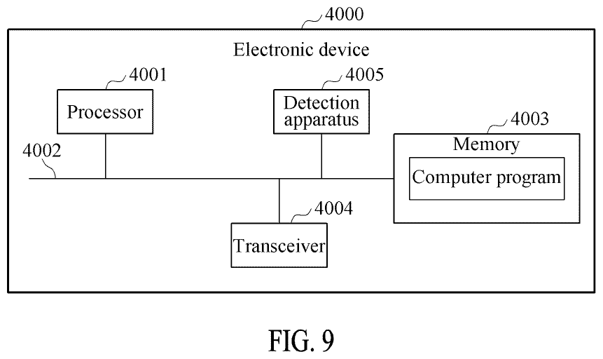

FIG. 9 illustrates an example of a configuration of an electronic device.

Referring to FIG. 9, an electronic device 4000 may include a processor 4001 (e.g., one or more processors), a memory 4003 (e.g., one or more memories), and a detection apparatus 4005. The processor 4001 may be connected to the memory 4003 via a bus 4002. The electronic device 4000 may further include a transceiver 4004 for data interaction (e.g., data transmission and reception between other electronic devices) with an electronic device 4000. In an actual application, the number of transceivers 4004 is not limited to one transceiver, and the structure of the electronic device 4000 may not be limited to the examples described herein. Optionally, the electronic device 4000 may be a first network node, a second network node, or a third network node.

The processor 4001 may be a CPU, a general-purpose processor, a digital signal processor (DSP), an application-specific integrated circuit (ASIC), a field programmable gate array (FPGA) or other programmable logic devices, a transistor logic device, a hardware component, or any combination thereof. This may implement or execute each of the logic blocks, modules, or circuits described with reference to the examples described herein. The processor 4001 may also be a combination that implements a determining function, and may include, for example, a combination of one or more microprocessors, a combination of a DSP and a microprocessor, etc.

The bus 4002 may include a path for transmitting information between the components described above. The bus 4002 may be a peripheral component interconnect (PCI) bus, an extended industry standard architecture (EISA) bus, etc. The bus 4002 may be classified into an address bus, a data bus, a control bus, etc. For ease of description, in FIG. 9, the bus 4002 is represented using a single bold line, but this may not indicate that there is only one bus or only one type of bus.

The memory 4003 may be, but is not limited thereto, random access memory (RAM), another type of static storage device for storing information and instructions, electrically erasable programmable read-only memory (EEPROM), a compact disc ROM (CD-ROM), other optical disc storages, an optical disc storage (including a compact disc, a laser disc, an optical disc, a digital versatile disc (DVD), a Blu-ray disc, and the like), a magnetic disk storage medium, other magnetic storage devices, or any other computer-readable storage medium that may be used to return or store program code in the form of instructions or data structures and may be accessed by a computer.

The memory 4003 may be used to store a computer program for executing the examples of the present disclosure and may be controlled by the processor 4001 for execution. The processor 4001 may execute the computer program stored in the memory 4003 to realize the operations of the examples of the methods described above. In an example, the memory 4003 may include a non-transitory computer-readable storage medium storing code that, when executed by the processor 4001, configures the processor 4001 to perform any one, any combination, or all of the operations and/or methods disclosed herein with reference to FIGS. 1-9.

The detection apparatus 4005 may include a LIDAR sensor and/or an RGB-D sensor (e.g., including an RGB camera and a depth sensor) that captures point cloud data.

In an aspect, an example of the present disclosure may provide a method performed by an electronic device.

The method may include obtaining point cloud data, in which the point cloud data may include related information of a plurality of points, and the related information may include at least one piece of 3D coordinate information.

The method may include sorting the plurality of points based on the 3D coordinate information of the plurality of points.

The method may include obtaining feature information of the plurality of points using a 1D CNN, based on the related information of the plurality of sorted points.

The method may include processing the point cloud data based on the feature information of the plurality of points.

In another aspect, an example of the present disclosure may provide an electronic device, in which the electronic device may include at least one processor, and the at least one processor may be configured to perform a method provided in any one optional example of the present disclosure.

Optionally, the electronic device may further include a transceiver connected to the at least one processor.

Optionally, the electronic device may further include a memory, in which the memory may store a computer program, and when the at least one processor executes the computer program, the method provided in the examples of the present disclosure may be performed.

In still another aspect, an example of the present disclosure may provide a non-transitory computer-readable storage medium, in which the non-transitory computer-readable storage medium may store a computer program, and when the computer program is executed by the at least one processor, the method provided in any one optional example of the present disclosure may be performed.

In still another aspect, an example of the present disclosure may provide a computer program product, in which the computer program product may include a computer program, and when the computer program is executed by the at least one processor, the method provided in any one optional example of the present disclosure may be implemented.

An example of the present disclosure may provide a non-transitory computer-readable storage medium, in which a computer program may be stored in the non-transitory computer-readable storage medium, and when the computer program is executed by the at least one processor, the operations and contents of the examples of the methods described above may be implemented.

An example of the present disclosure may further provide a computer program product, and when the computer program product includes a computer program and the computer program is executed by the at least one processor, the operations and contents of the examples of the methods described above may be implemented.

Terms such as “first,” “second,” “third,” “fourth,” “1,” and “2” (if present) in the description, claims, and drawings of the present specification are intended to distinguish the component from other components, and the nature, the sequences, or the orders of the components are not limited by the terms.

Although each operation is indicated by an arrow in the flowchart of the example of the present disclosure, the order of the operations is not limited to the order indicated by the arrow. Unless otherwise described in this specification, in some implementations of the example of the present disclosure, the operations of each flowchart may be performed differently according to requirements. In addition, some operations or all operations of the flowchart may include several sub-operations according to the actual implementation, and some sub-operations or all sub-operations may be executed simultaneously or at different times, and the execution order may be flexibly configured as needed.

While the examples are described with reference to drawings, it will be apparent to one of ordinary skill in the art that various alterations and modifications in form and details may be made in these examples without departing from the spirit and scope of the claims and their equivalents. For example, suitable results may be achieved if the described techniques are performed in a different order and/or if components in a described system, architecture, device, or circuit are combined in a different manner and/or replaced or supplemented by other components or their equivalents. Therefore, other implementations, other examples, and equivalents to the claims are also within the scope of the following claims.

The electronic devices, processors, buses, memories, transceivers, electronic device 4000, processor 4001, bus 4002, memory 4003, and transceiver 4004 described herein, including descriptions with respect to respect to FIGS. 1-9, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-9 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
obtaining point cloud data comprising records indicating positions and attributes of a plurality of points;
sorting the records according to an order of the plurality of points determined based on the positions of the plurality of points;
extracting features of the plurality of points, based on a result obtained by applying a feature extraction model to input data based on the sorted records; and
processing the point cloud data based on the features of the plurality of points.

2. The method of claim 1, wherein
each of the records comprises coordinate values of a plurality of coordinate axis directions indicating a position of a point corresponding to a corresponding record, and
the sorting of the records comprises determining the order of the plurality of points, based on priorities assigned to the plurality of coordinate axis directions.

3. The method of claim 2, wherein the determining of the order of the plurality of points comprises, based on a difference between coordinate values in a first coordinate axis direction between two points being less than or equal to a threshold value, determining that the difference between the coordinate values in the first coordinate axis direction between the two points does not exist.

4. The method of claim 1, wherein the sorting of the records comprises:
selecting a reference point from among the plurality of points;
determining, among points of which an order is not determined among the plurality of points, an order of a target point that is closest to the reference point to be a next order of the reference point; and
repeatedly updating the target point to the reference point and repeatedly determining the order of the target point, based on the updated reference point, until an order of all the plurality of points is determined.

5. The method of claim 1, wherein
each of the records comprises item values of a plurality of items comprising a position item and an attribute item, and
the extracting of the features of the plurality of points comprises, using each item of the sorted records as one channel, obtaining the input data comprising the sorted records with a plurality of channels.

6. The method of claim 1, wherein the feature extraction model comprises a one-dimensional (1D) convolutional neural network (CNN) comprising a 1D convolution operation that determines a convolution with an input while sliding a kernel, which is a 1D tensor, along one axis.

7. The method of claim 1, wherein
the feature extraction model comprises a first convolution module comprising a 1D convolution operation and a second convolution module comprising a 1D convolution operation,
the sorting of the records comprises sorting the records in a first order of the plurality of points determined according to a first reference assigned to the first convolution module, and
the extracting of the features of the plurality of points comprises:
obtaining intermediate features of the plurality of points, based on a result obtained by applying the first convolution module to first input data based on the records sorted in the first order; and
obtaining the features of the plurality of points, based on a result obtained by applying the second convolution module to second input data based on the obtained intermediate features.

8. The method of claim 7, wherein the extracting of the features of the plurality of points further comprises:
sorting the intermediate features in a second order of the plurality of points determined according to a second reference assigned to the second convolution module; and
applying the second convolution module to the second input data based on the intermediate features sorted in the second order.

9. The method of claim 1, wherein
the feature extraction model comprises a first convolution layer and a second convolution layer, and
the extracting of the features of the plurality of points comprises:
extracting, in the first convolution layer, item mixture features indicating features based on item values of items for each of the points, based on a 1D convolution of a first kernel and the input data, wherein the 1D convolution of the first kernel and the input data is determined while sliding the first kernel, which is a 1D tensor, along an item axis of the input data; and
extracting, in the second convolution layer, spatial mixture features indicating features between each of the points and an adjacent one of the points that is adjacent to a corresponding one of the points, based on a 1D convolution of a second kernel and the input data, wherein the 1D convolution of the second kernel and the input data is determined while sliding the second kernel, which is a 1D tensor, along a point axis of the input data.

10. The method of claim 1, wherein
the obtaining of the point cloud data comprises:
obtaining primary point cloud data corresponding to a first time point; and
obtaining secondary point cloud data corresponding to a second time point that is temporally adjacent to the first time point,
the sorting of the records comprises:
determining an order of points in an entire point set comprising first points of the primary point cloud data and second points of the secondary point cloud data; and
sorting records of the primary point cloud data and records of the secondary point cloud data according to the determined order of the points in the entire point set,
the extracting of the features of the plurality of points comprises obtaining features of the points in the entire point set using the feature extraction model, and
the processing of the point cloud data comprises, among the features of the points in the entire point set, processing the primary point cloud data using features of the first points.

11. The method of claim 1, wherein
the point cloud data comprises the records respectively corresponding to the plurality of points, and
each of the records of the point cloud data comprises an item value of one or more position items indicating a position of a corresponding point and an item value of one or more attribute items indicating an attribute of a corresponding point.

12. The method of claim 11, wherein the one or more attribute items comprises either one or both of one or more color items and a reflection intensity item.

13. The method of claim 1, wherein the processing of the point cloud data comprises dividing the plurality of points into a plurality of partial point sets by classifying the plurality of points, based on the features of the plurality of points.

14. The method of claim 1, wherein the processing of the point cloud data comprises determining an object corresponding to one or more points, based on the features of the plurality of points.

15. A non-transitory computer-readable storage medium storing code that, when executed by one or more processors, configures the one or more processors to perform the method of claim 1.

16. An electronic device comprising:
one or more processors configured to:
obtain point cloud data comprising records indicating positions and attributes of a plurality of points;
sort the records according to an order of the plurality of points determined based on the positions of the plurality of points;
extract features of the plurality of points, based on a result obtained by applying a feature extraction model to input data based on the sorted records; and
process the point cloud data based on the features of the plurality of points.

17. The electronic device of claim 16, wherein
each of the records comprises coordinate values of a plurality of coordinate axis directions indicating a position of a point corresponding to a corresponding record, and
the one or more processors are configured to determine the order of the plurality of points, based on priorities assigned to the plurality of coordinate axis directions.

18. The electronic device of claim 16, wherein, for the sorting of the records, the one or more processors are configured to:
select a reference point from among the plurality of points;
determine, among points of which an order is not determined among the plurality of points, an order of a target point that is closest to the reference point to be a next order of the reference point; and
repeatedly update the target point to the reference point and repeatedly determine the order of the target point, based on the updated reference point, until an order of all the plurality of points is determined.

19. The electronic device of claim 16, wherein
the feature extraction model comprises a first convolution module comprising a one-dimensional (1D) convolution operation and a second convolution module comprising a 1D convolution operation, and
the one or more processors are configured to:
for the sorting of the records, sort the records in a first order of the plurality of points determined according to a first reference assigned to the first convolution module;
for the extracting of the features of the plurality of points, obtain intermediate features of the plurality of points, based on a result obtained by applying the first convolution module to first input data based on the records sorted in the first order; and
for the extracting of the features of the plurality of points, obtain the features of the plurality of points, based on a result obtained by applying the second convolution module to second input data based on the obtained intermediate features.

20. The electronic device of claim 16, wherein
the feature extraction model comprises a first convolution layer and a second convolution layer, and
for the extracting of the features of the plurality of points, the one or more processors are configured to:
extract, in the first convolution layer, item mixture features indicating features based on item values of items for each point, based on a 1D convolution of a first kernel and the input data, wherein the 1D convolution of the first kernel and the input data is determined while sliding the first kernel, which is a 1D tensor, along an item axis of the input data; and
extract, in the second convolution layer, spatial mixture features indicating features between each point and an adjacent point that is adjacent to a corresponding point, based on a 1D convolution of a second kernel and the input data, wherein the 1D convolution of the second kernel and the input data is determined while sliding the second kernel, which is a 1D tensor, along a point axis of the input data.
